(19) United States
(12) Patent Application Publication
(10) Pub. No.: US 2003/0168290 A1
(43) Pub. Date: Sep. 11, 2003

(54) Elevator without machine room

(76) Inventors: Kazuaki Miyakoshi, Fuchu-shi (JP); Masahiro Bunya, Fuchu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/168,045

(22) PCT Filed: Oct. 19, 2001
(86) PCT No.: PCT/JP01/09147

(30) Foreign Application Priority Data
Oct. 19, 2001 (JP) 2000-320658

(51) Int. Cl. B66B 17/12

(52) U.S. Cl. 187/405; 187/404

(57) ABSTRACT

In a normal operation mode, an upper counterweight (3a) and a lower counterweight (3b) are coupled together by an attachment/detachment device (4), and an operation is performed in this state. In a rescue operation mode, the upper counterweight (3a) and the lower counterweight (3b) are disconnected by the attachment/detachment device (4), and the lower counterweight (3b) is fixed to the counterweight guide rail by means of a fixing device (5). An operation is performed, using only the upper counterweight (3a). A control device is installed at a shaft position in the neighborhood of the top floor. If this control device becomes out of order, the serviceperson can move to a position which is near the control device.

### TECHNICAL FIELD

The present invention relates to a machine room-less elevator.

### BACKGROUND ART

In recent years, machine room-less elevators have come to be used since the elevators of this type allow the installation space to be compact. A machine room-less elevator employs a slim motor for driving an elevator car. This electric motor is located at the uppermost portions of a pair of opposing guide rails for guiding the elevator car.

In general, the control device the machine room-less elevator employs for controlling the driving of the elevator car is provided as part of a trigonal frame, which is located near the elevator hall of the top floor. Due to the restrictions imposed by the design of the elevator hall and by the pillars of the building, it is proposed that the control device is installed at the pit in the bottom region of the shaft, instead of installing it in the trigonal frame. If installed at the pit, however, the control device may be submerged in water, so that measures should be taken to prevent this situation.

Instead of installing the control device in the trigonal frame or the pit in the shaft, it may be thought to attach the control device directly to a wall that defines the shaft. In this case, the control device can be installed at any position desired, as long as it is located higher than the pit. Most desirably, the control device is installed at a position in the neighborhood of the top floor.

In the case where the control device is located at a shaft position in the neighborhood of the top floor, the machine room-less elevator has the following problem. If the control device becomes out of order, and the elevator car stops in the neighborhood of the top floor, the elevator itself car may be an obstacle to the access to the control device.

More specifically, if the elevator car stops in the neighborhood of the top floor due to a malfunction of the control device, the passengers must be rescued by use of a brake releasing device. The elevator car moves up to the top floor when it is lighter than the counterweight and moves down to the first (or ground) floor when it is heavier than the counterweight. Rescue work is done either at the top floor or at the first floor.

A suspended well bucket type elevator is designed in such a manner that the counterweight is well-balanced with the elevator car when a predetermined number of passengers are on the car. When no passenger is on the car, the counterweight is heavier. On the other hand, when the car is filled to capacity, the car is heavier.

When the passengers have been rescued and the serviceperson is about to get on the car, the counterweight is heavier than the car because no passenger is on the car then. Accordingly, the car moves up as soon as the brake is released. Where, after a rescue operation, the car is located at a position one floor lower from the top floor, the serviceperson can easily move onto the ceiling of the car from the top floor. However, where the car is located at the top floor, it is hard for the serviceperson to do so. As a result, access to the control device is not easy.

In a machine room-less elevator wherein the control device is installed at a shaft position in the neighborhood of the top floor, let us assume that the control device becomes out of order when the elevator car is light in weight and located at a position in the neighborhood of the top floor. Since the counterweight is heavier in this unbalanced state, the car cannot be moved to a position lower than the control device by operating the brake releasing device.

### DISCLOSURE OF INVENTION

An object of the present invention is to provide a machine room-less elevator which allows a serviceperson to access to a control device if this control device becomes out of order.

This object is attained by the following machine room-less elevator. The present invention relates to a machine room-less elevator wherein a car is suspended at one end of the rope, and a counterweight at the other end.

The counterweight is made up of a first counterweight and a second counterweight. The weight of the first counterweight is applied to the rope in a rescue operation mode, while the total weight of the first and second counterweights is applied to the rope in a normal operation mode.

According to the present invention, the elevator is driven in the normal operation mode in such a manner that the weight of both the first and second counterweights is applied to the rope. In the rescue operation mode, the elevator is driven in such a manner that the weight of only the first counterweight is applied to the rope.

If the elevator car becomes out of order at a position in the neighborhood of the top floor, it can be moved down by operating the braking device, and the serviceperson can get onto the ceiling of the car.

In the case where the control device is disposed at a shaft position in the neighborhood of the top floor, the serviceperson can easily give access to the control device and repair it.

### BRIEF DESCRIPTION OF DRAWINGS

FIG. 1 is a structural view showing a machine room-less elevator according to the first embodiment of the present invention.

FIG. 2 is an explanatory view showing the counterweight employed in the first embodiment of the present invention.

FIG. 3 is a flowchart illustrating how a lower counterweight, which is temporarily separated, is attached to an upper counterweight after a control device of the first embodiment of the present invention is recovered.

FIG. 4 is a structural view showing a machine room-less elevator according to the second embodiment of the present invention.

FIG. 5 is an explanatory view showing the counterweight employed in the second embodiment of the present invention.

FIG. 6 is an explanatory view showing the counterweight employed in a machine room-less elevator according to the third embodiment of the present invention.

FIG. 7 is an explanatory view showing the counterweight employed in a machine room-less elevator according to the fourth embodiment of the present invention.

FIG. 8 is an explanatory view showing the counterweight employed in a machine room-less elevator according to the fifth embodiment of the present invention.

FIG. 9 is an explanatory view showing the counterweight employed in a machine room-less elevator according to the sixth embodiment of the present invention.

FIG. 10 is an explanatory view showing another machine room-less elevator according to the sixth embodiment of the present invention.

### BEST MODE FOR CARRYING OUT OF THE INVENTION

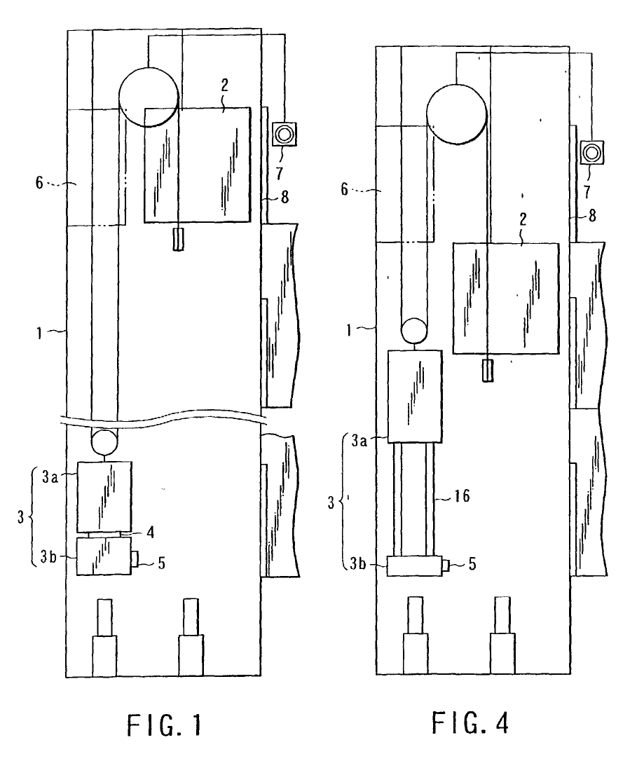

Embodiments of the present invention will now be described. FIG. 1 is a structural view showing a machine room-less elevator according to the first embodiment of the present invention.

An elevator car 2 and a counterweight 3 move up or down in a shaft 1. The counterweight is made up of an upper counterweight (first counterweight) 3a and a lower counterweight (second counterweight) 3b, which are attachable to, and detachable from each other by means of an attachment/detachment device 4. The lower counterweight 3b is fixed to counterweight guide rails (not shown) when it is detached from the upper counterweight 3a.

The counterweight 3 is designed to be in the unbalanced condition when the upper and lower counterweights 3a and 3b are coupled. The unbalancing direction is reversed by dividing the counterweight 3, i.e., by separating the lower counterweight 3b from the counterpart.

Normally, the elevator car 2 moves up or down in the shaft 1, with passengers therein. When a control device 6 is out of order or at the time of maintenance, the ceiling of the elevator car 2 is used as a scaffold for the serviceperson. The control device 6 is slim and does not become an obstacle to the vertical movement of the car 2 and the counterweight 3. The car 2 and the counterweight 3 are away from each other by a safe distance even when they are closest.

A brake releasing device 7 releases a brake either mechanically or electrically, and is used when the control device 6 becomes out of order and a rescue operation is performed. By way of example, let us assume that the control device 6 becomes out of order and the car 2 stops at a position in the neighborhood of the top floor. In this state, the brake releasing device 7 is operated gradually to move the car 2 upward. When the car 2 has reached the elevator hall of the top floor, the brakes are applied, and the door at the elevator hall of the top floor is opened to rescue the passengers in the car 2. Next, the counterweight 3 is divided, thereby creating an unbalanced state where the car 2 moves downward. The brake releasing device 7 is gradually operated until the ceiling of the car 2 comes to the same level as the elevator hall of the top floor. When the ceiling of the car 2 comes to this level, the door 8 of the elevator hall of the top floor is opened, and the serviceperson moves onto the ceiling of the car 2 and repairs the control device 6.

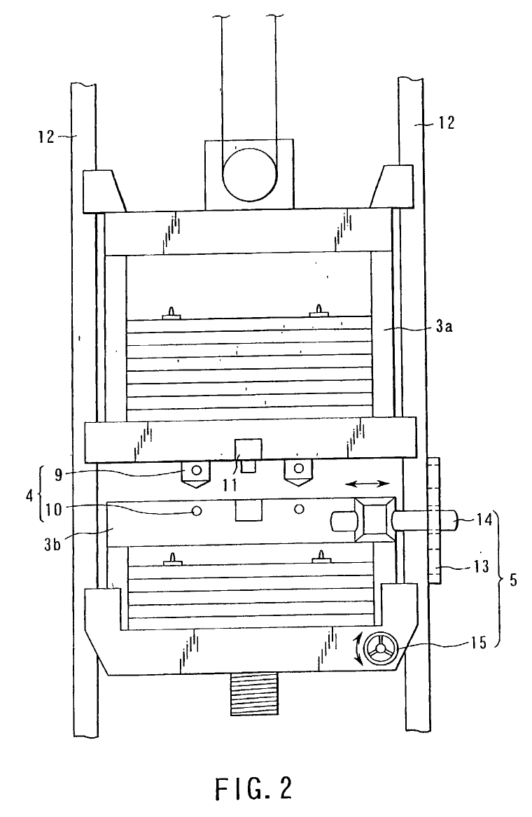

FIG. 2 is an explanatory view showing the counterweight 3 employed in the first embodiment of the present invention. The attachment/detachment device 4 includes coupling units 9 provided on the bottom of the upper counterweight 3a, and coupling holes 10 formed in the lower counterweight 3b. Coupling shafts are inserted through the coupling holes of the coupling units 9 and the coupling holes 10 of the lower counterweight 3b. A coupling detector 11 detects whether or not the coupling holes of the coupling units 9 correspond in position to the coupling holes 10 of the lower counterweight 3b.

To detach the upper and lower counterweights 3a and 3b away from each other, the lower counterweight 3b is first fixed to the counterweight guide rails 12, using a fixing device 5. The fixing device 5 includes the following: a fixing bracket 13 provided for the counterweight guide rails 12; a fixing rod 14 provided for the lower counterweight 3b and fixing the lower counterweight 3b together with the fixing bracket 13; and an operating wheel 15 with which to insert the fixing rod 14 into the fixing bracket 13.

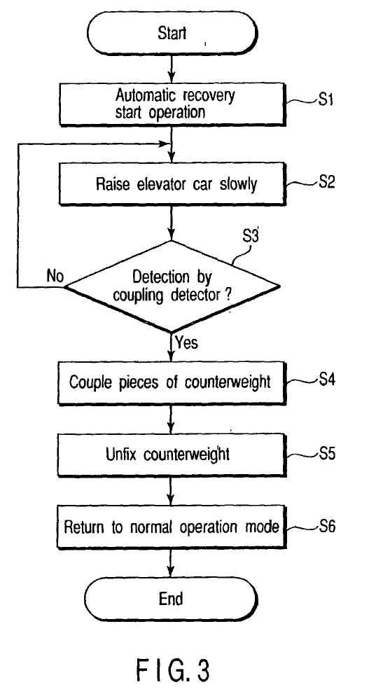

FIG. 3 is a flowchart illustrating how the lower counterweight 3b, which is temporarily separated, is attached to the upper counterweight 3a after the control device 6 is recovered. The lower counterweight 3b is fixed to the counterweight guide rails 12, using the fixing device 5.

After the control device 6 is repaired, the serviceperson executes an automatic recovery start operation (S1) so that the elevator car 2 is raised slowly (S2). When the car 2 is raised, the upper counterweight 3a is lowered onto the lower counterweight 3b. Then, the coupling detector 11 detects or determines whether or not the coupling units 9 have reached the coupling holes 10 (S3). If the upper and lower counterweights 3a and 3b are not coupled, the control flow returns to step S2.

If the determination in step S3 shows a coupled state, the raising of the elevator car 2 is stopped. In this state, the serviceperson enters the pit in the shaft 1 to confirm that the upper and lower counterweights 3a and 3b are coupled together and to insert a coupling rod into each coupling hole 10, thereby coupling the divided pieces of the counterweight 3 (S4). In this manner, the counterweight 3 does not separate during the normal operation.

After the divided pieces of the counterweight 3 have been coupled together, the serviceperson operates the operating wheel 15 of the fixing device 5 to pull the fixing rod 14 from the fixing bracket 13. As a result, the counterweight 3 is released from the fixed state (S5). The serviceperson comes out of the pit, and executes a process of returning to a normal operation mode (S6), thereby completing the recovery operation.

As described above, the first embodiment can reverse the unbalancing direction. That is, when the counterweight 3 is in the coupled state, it is heavier than the elevator car 2 in the unbalanced state. On the other hand, when the counterweight 3 is in the divided state, the elevator car 2 is heavier in the unbalanced state. With this structure, the elevator car 2 can be lowered by operating the brake releasing device 7, and the serviceperson can get on the ceiling of the elevator car 2 and move to a position which is near the control device 6. Thus, the serviceperson can repair the control device 6.

When the counterweight is divided, the lower counterweight 3b is fixed to the counterweight guide rails 11, using the fixing device 5. Therefore, the lower counterweight 3b is prevented from moving into a counterweight buffer, which is at the bottom of the shaft 1.

The second embodiment of the present invention will now be described. FIG. 4 is a structural view showing a machine room-less elevator according to the second embodiment of the present invention. The second embodiment differs from the first embodiment shown in FIG. 1 in that a gap adjusting device 16 is additionally employed to adjust the gap between upper and lower counterweights 3a and 3b. Except for this, the structures of the second embodiment are similar to those of the first embodiment shown in FIG. 1, and a repeated description of them will be omitted by attaching the same reference numerals as used in the first embodiment. In FIG. 4, illustration of the attachment/detachment device 4 is omitted.

The gap adjusting device 16 is disposed between the upper and lower counterweights 3a and 3b. In the state where the lower counterweight 3b is disconnected and fixed to the counterweight guide rails (not shown) by the fixing device 5, the gap adjusting device 16 is operated to adjust the gap between the upper and lower counterweights 3a and 3b.

With the disconnected lower counterweight 3b being fixed by the fixing device 5, the gap between the upper and lower counterweights 3a and 3b is adjusted in such a manner as to raise the upper counterweight 3a. The elevator car 2, which is connected to the counterweight 3 with a rope, is raised, accordingly. Hence, if the elevator car 2 becomes out of order in the neighborhood of the top floor, it is first moved to a position where the passengers can be rescued, and is then moved down.

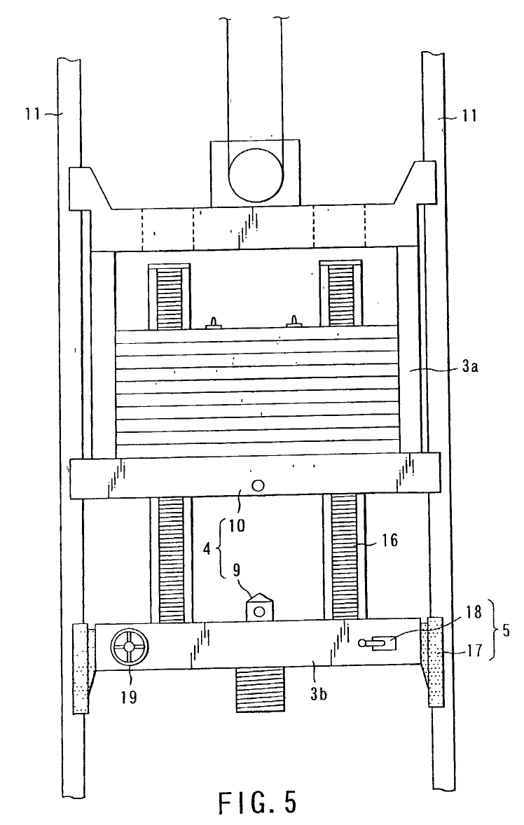

FIG. 5 is an explanatory view showing the counterweight employed in the second embodiment of the present invention. An attachment/detachment device 4 includes coupling units 9 provided on the upper surface of the lower counterweight 3b, and coupling holes 10 formed in the upper counterweight 3b. Coupling shafts (not shown) are inserted through the coupling holes of the coupling units 9 and the coupling holes 10 of the upper counterweight 3a.

To detach the upper and lower counterweights 3a and 3b from each other, the lower counterweight 3b is fixed to counterweight guide rails 12, using a fixing device 5. The fixing device 5 includes a pressure-fixing portion 17 provided for the lower counterweight 3b and fixing the lower counterweight 3b to the counterweight guide rails 12, and an operating lever 18 with which to operate the pressure-fixing portion 17.

A gap adjusting device 16 adjusts the gap of the counterweight when the serviceperson operates a gap adjusting wheel 19 to turn a ball screw. To be more specific, the pressure-fixing portion 17 of the lower counterweight 3b is operated relative to the lower counterweight 3b by taking hold of the operating lever 18, and the lower counterweight 3 is fixed to the counterweight guide rails 11. Thereafter, the gap adjusting device 15 and the gap adjusting wheel 19 are operated to raise the upper counterweight 3a relative to the lower counterweight 3b.

According to the second embodiment, the upper counterweight 3 can be raised and the elevator car 2 can be lowered, by operating the brake releasing device 7. The serviceperson can therefore move to a position which is near the control device 6 located at a shaft position in the neighborhood of the top floor, and can repair the control device 6.

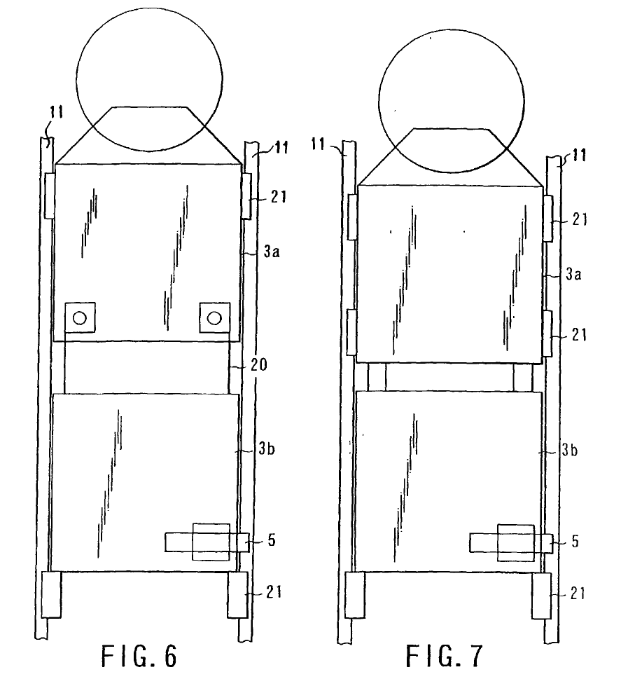

The third embodiment of the present invention will be described. FIG. 6 is an explanatory view showing the counterweight employed in a machine room-less elevator according to the third embodiment of the present invention. The third embodiment differs from the first embodiment shown in FIG. 1 in that connection means 20 is provided between the upper and lower counterweights 3a and 3b. The connection means does not lengthen if the brake is released and the displacement acceleration between the upper and lower counterweights 3a and 3b exceeds a predetermined value in the state where the lower counterweight 3b is disconnected and fixed to the counterweight guide rails 11 by means of the fixing device 5. In FIG. 6, illustration of both the detachment/attachment apparatus 4 and the counterweight guide rails 11 is omitted. The guide device 21 shown in the Figure serves to guide the counterweight 3 along the counterweight guide rails 11.

The connection means 20 pays out belts in accordance with the movement of the upper counterweight 3a. When the displacement acceleration of the upper counterweight 3a exceeds the predetermined value, the operation of paying out the belts stops.

More specifically, the counterweight 3 is divided, and the lower counterweight 3b is fixed to the counterweight guide rails 11. Then, the elevator car 2 is lowered by use of the brake releasing device 7. If the displacement acceleration of the upper counterweight 3a exceeds the predetermined value during the lowering of the elevator car 2, the connection means 20 stops the movement of the upper counterweight. Therefore, if the brake is released for some reason or other, the connection means 20 stops the upper counterweight 3a, thereby stopping the lowering of the elevator car 2.

According to the third embodiment, the counterweight is divided into upper and lower pieces, and the lower counterweight 3b is fixed to the counterweight guide rails 11. Thereafter, the elevator car 2, which is then positioned at the top floor, is lowered. Even if the brake is kept in the released state for some reason or other, the connection means 20 serves to prevent unintended movement of the elevator car 2.

The fourth embodiment of the present invention will now be described. FIG. 7 is an explanatory view showing the counterweight employed in a machine room-less elevator according to the fourth embodiment of the present invention. The fourth embodiment is featured in that guide devices 21 slidable along the counterweight guide rails 11 are provided for the upper and lower portions of the upper counterweight 3a, respectively. After division of the counterweight 3, the upper counterweight 3a is guided by the upper and lower guide devices when it vertically moves along the counterweight guide rails 11. Since the counterweight 3 is prevented from derailing, smooth movement is ensured.

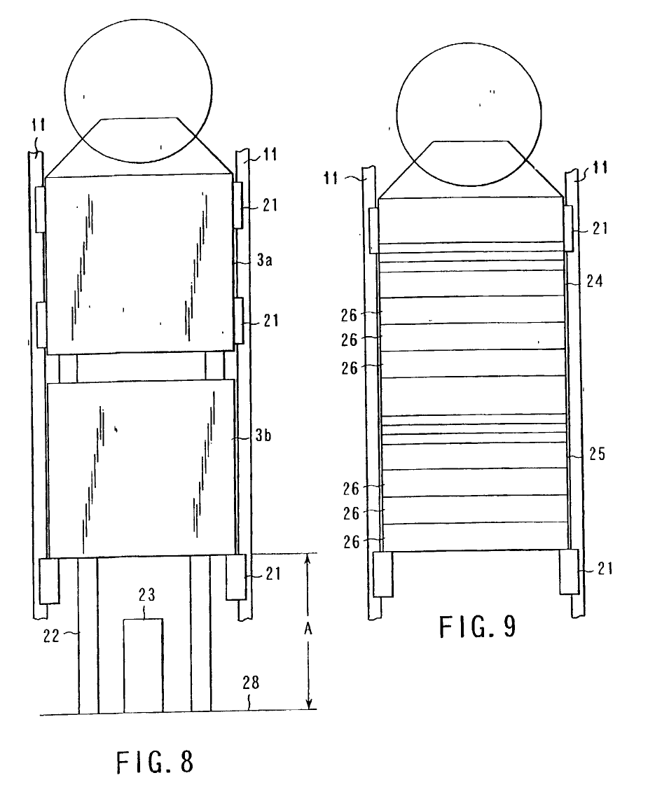

The fifth embodiment of the present invention will now be described. FIG. 8 is an explanatory view showing the counterweight 3 employed in a machine room-less elevator according to the fifth embodiment of the present invention. The fifth embodiment is featured in that the fixing device 5 described above is replaced with a counterweight lowering-preventing device 22 located between the counterweight 3 and the pit floor inside the shaft. When the elevator car 2 is located at a position corresponding to the top floor, the counterweight lowering-preventing device 22 prevents the lower counterweight 3b from moving down.

When the counterweight 3 is divided in the foregoing embodiments, it is pushed down and kept in contact with the buffer 23 so as to prevent the downward movement of the lower counterweight 3b. Instead of this, the fifth embodiment disposes the counterweight lowering-preventing device 22 between the lower portion of the lower counterweight 3b and the pit 28. The distance A between the lower counterweight 3b and the pit A is therefore constant irrespective of the rescue conditions. Hence, the counterweight 3 need not be pushed down to the buffer 23 and yet downward movement of the counterweight 3 is prevented. The counterweight 3 can be divided without being pushed down, and its downward movement is reliably prevented.

The sixth embodiment of the present invention will now be described. FIG. 9 is an explanatory view showing the counterweight 3 employed in a machine room-less elevator according to the sixth embodiment of the present invention. The sixth embodiment is featured in that the counterweight is made up of an upper counterweight section (a first counterweight section) 24 and a lower counter section (a second counterweight section) 25 and that a plurality of weights 26 are stacked in each counterweight section in such a manner that they can be selectively inserted or removed.

Because of the above structure, the counterweight need not be complicated, such as a dividable type. The elevator car 2 and the counterweight 3 can be balanced by inserting or removing weights from either the upper counterweight section 24 or the lower counterweight section 25.

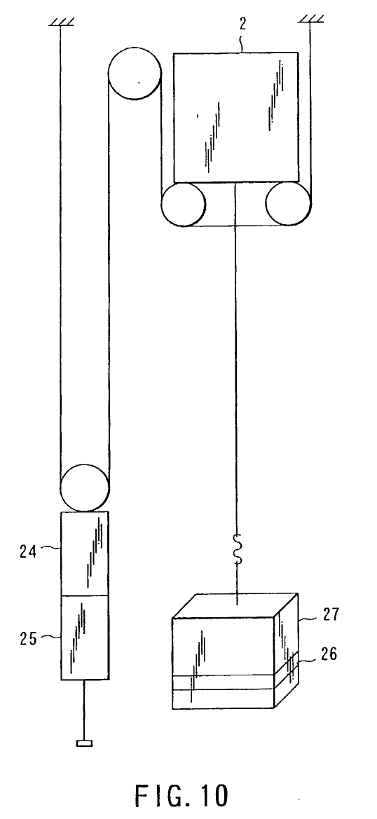

As shown in FIG. 10, a weight frame 27 may be provided for the elevator car 2, and weights taken out from either the upper counterweight 24 or the lower counterweight 25 can be suspended in the weight frame 27. For example, a weight 26 taken out from the lower counterweight 25 is transferred into the weight frame 27, thereby increasing the weight of the elevator car 2.

According to the sixth embodiment, weights 25 taken out from either the upper counterweight 24 or lower counterweight 25 can be added one by one as part of the weight of the elevator car 2. As a natural consequence of this, the unbalance between the elevator car 2 and the counterweight 3 is reduced to half that of a normal case. Since the weights 26 that must be taken out from either the upper counterweight 24 or the lower counterweight 25 are about half, the required labor and time can be reduced, accordingly.

### INDUSTRIAL APPLICABILITY

As described above, even if the control device at a shaft position in the neighborhood of the top floor becomes out of order, and the elevator car cannot be moved down to a position lower than the control device by merely operating the brake releasing device, the counterweight can be divided into pieces, and the unbalancing direction can be reversed between the elevator car and the counterweight. Since the elevator can be moved toward the control device positioned in the neighborhood of the top floor, the control device can be repaired easily.

1. A machine room-less elevator wherein an elevator car is suspended at one end of a rope and a counterweight is suspended at another end,
said counterweight including a first counterweight and a second counterweight, the first counterweight being applied to the rope in a normal operation mode, and both the first and second counterweights being applied to the rope in a rescue operation mode.

2. A machine room-less elevator according to claim 1, wherein said counterweight has a two-piece structure forming the first and second counterweights.

3. A machine room-less elevator according to claim 2, wherein said lower counterweight is attached to the upper counterweight in a detachable manner, an attachment/detachment device which attaches or detaches the upper and lower counter weights from each other is provided for one of the upper and lower counterweights, a guide rail is provided in the shaft, and the lower counterweight disconnected by the attachment/detachment device is fixed to the counterweight guide rail.

4. A machine room-less elevator according to claim 1, further comprising a gap adjusting device which is located between the upper and the lower counterweights and which adjusts a gap between the upper and lower counterweights.

5. A machine room-less elevator according to claim 4, further comprising guide devices which are provided on upper and lower portions of the upper counterweight and are slidable on the counterweight guide rail.

6. A machine room-less elevator according to claim 3, comprising connection means which is located between the upper and lower counterweights and which does not lengthen if a displacement acceleration between the upper and lower counterweights exceeds a predetermined value.

7. A machine room-less elevator according to claim 6, further comprising guide devices which are provided on upper and lower portions of the upper counterweight and are slidable on the counterweight guide rail.

8. A machine room-less elevator according to claim 3, further comprising guide devices which are provided on upper and lower portions of the upper counterweight and are slidable on the counterweight guide rail.

9. A machine room-less elevator according to claim 2, wherein said lower counterweight is attached to the upper counterweight in a detachable manner, an attachment/detachment device which attaches or detaches the upper and lower counter weights from each other is provided for one of the upper and lower counterweights, a guide rail is provided in the shaft, and a counterweight lowering-preventing device is located between the counterweight and a pit floor of the shaft.

10. A machine room-less elevator according to claim 1, wherein the first and second counterweights of the counterweight form a double-layer structure including an upper counterweight section and a lower counterweight section, and a plurality of weights are stacked on each counterweight section such that the weights can be selectively inserted or removed.

11. A machine room-less elevator according to claim 10, comprising a weight frame which permits part of the weights to be disposed under the elevator car.
